(19) United States
(12) Patent Application Publication
(10) Pub. No.: US 2004/0128151 A1
(43) Pub. Date: Jul. 1, 2004

(54) Method and apparatus for electronically updating changes in contact information

(76) Inventors: Von Alan Mock, Boynton Beach, FL (US); Robert K. Lockhart JR., Boynton Beach, FL (US)

Correspondence Address: MILLER JOHNSON SNELL CUMMISKEY, PLC, 800 CALDER PLAZA BUILDING, 250 MONROE AVE N W, GRAND RAPIDS, MI, 49503-2250, US

(21) Appl. No.: 10/335,794

(22) Filed: Dec. 31, 2002

(51) Int. Cl. G06F 17/60

(52) U.S. Cl. 705/1

(57) ABSTRACT

A method and apparatus for notifying of changes made to contact information (700, 800) in an electronic contact list includes updating a first electronic contact list with updated information (710) and electronically sending the updated information (720) to at least one second contact list (820) in an electronic format based upon changes made to the first contract list. Optionally, an acknowledgment (850) may be sent by the recipient of the contact information in order to delete the recipient from the sender's contact list.

### TECHNICAL FIELD

This invention relates in general to database updating and more particularly to the updating of personal or business contact information in a database used with application software.

### BACKGROUND

Many business professionals exchange paper business cards with customers or professionals as a greeting or as a means to provide future contact information. The exchange of this type of personal information often enhances the owner's ability to perform his respective job functions. Most users will manage their list of contacts utilizing commercially available software packages such as Microsoft Office™ or the like. In this electronic form, a user can easily search, apply notes, and/or update pertinent information to an electronic calendar or address book.

As is often recognized, at various times during the course of a person's career, their respective “contact” information may change. New employers, new contact methods, new titles, job role and new business responsibilities are some of the possible changes that might occur. As these changes occur during a person's career, the business professional will most often manually send out updated information to users in their own contact database. Updates can be sent as an industry standard format such as Vcard™ or though the use of other proprietary implementations. The recipient of the updated contact information will manually view and verify that the updated contact information warrants either updating or expulsion from his own contact database. The exercise of updating the information is a manual process for both sender and recipient of the information.

In addition, further problems arise when the sender has no status update for the new contact information sent to their recipient. The sender has no idea whether this information was received and if recipient's databases have been updated.

Therefore, there is a need for a method and apparatus by which a user's updated contact information might be automatically sent to a subscribing recipient listed in the user's database. Additionally, there is a further need to provide a method and apparatus to automatically send a status response back to the sender when the recipient takes an action on the updated contact information. Such a method and apparatus will enable a rapid and effective update of contact information and/or data to both a user and those in a user's database to more efficiently keep accurate and up-to-data contact information for personal or business use.

### SUMMARY OF THE INVENTION

Briefly, according to the invention, there is provided a method and apparatus for electronically updating contact information to persons listed within a user's contact list. Once updates have been made to a user's contact profile, these updates are selectively transmitted to recipients that match a specific profile. The received information update can be accepted or rejected, such that a response may be sent back to the sender requesting deletion from the sender's contact list. Moreover, a contact may also be deleted upon the expiration of a predetermined amount of time when no acknowledgement has been received by the sender.

### BRIEF DESCRIPTION OF THE DRAWINGS

The features of the present invention, which are believed to be novel, are set forth with particularly in the appended claims. The invention, together with further objects and advantages thereof, may best be understood by reference to the following description, taken in conjunction with the accompanying drawings, in the several figures of which like reference numerals identify like elements, and in which:

FIG. 1 is a block diagram of a conventional wide area network system configured for operation in accordance with the present invention;

FIG. 2 illustrates an electronic information processing device configured for operation in accordance with the preferred embodiment of the present invention;

FIG. 3 is a block diagram illustrating a method describing how an owner of contacts can create a plurality of user associations;

FIG. 4 is a block diagram illustrating a method where the owner of contacts can create a plurality of user associations;

FIG. 5 is block diagram describing a method for storing a user's contact information;

FIG. 6 is a block diagram further describing FIG. 5 illustrating details of a user's contact information;

FIG. 7 is a block diagram illustrating a contact list contained with an electronic device that tracks one or more contacts within profiles as seen in FIG. 4;

FIG. 8 is a block diagram illustrating the creation of a list of transmitted contacts;

FIG. 9 is a flowchart illustrating a method for broadcasting contact information updates in a peer-to-peer fashion to each member of a profile that has a subscription request, once the user updates the contact information for a particular profile;

FIG. 10 is a flowchart illustrating a method of a recipient's electronic device that has received another user's contact information;

FIG. 11 is a flowchart illustrating a method for tracking recipient responses and deciding whether to remove the contact within a profile from the sender's contact database; and

FIG. 12 is a flowchart diagram illustrating a method where a contact can be deleted from a user database upon the expiration of some predetermined time period.

### DETAILED DESCRIPTION OF THE PREFERRED EMBODIMENT

While the specification concludes with claims defining the features of the invention that are regarded as novel, it is believed that the invention will be better understood from a consideration of the following description in conjunction with the drawing figures, in which like reference numerals are carried forward.

As seen in the accompanying figures, the following description is to serve as one of the several methods available for implementing the disclosed invention. Although this method is tailored to Microsoft Office Outlook™, it will be recognized by those skilled in the art that it could be extended to other software applications as well.

Software development companies such as Microsoft Corporation typically provide published software application interfaces within their email application software framework. Microsoft Office Outlook™ is one such application. Collaboration Data Objects (CDO) and Messaging Application Interface (MAPI) are the Application Program Interface's (API) that exist that allow software programmers to access the underlying databases of information that are controlled by Microsoft Office Outlook™. Knowledge of these API's and the implementation of the Vcard™ standard would allow for a person to create a Microsoft Office Outlook™ add-on. Both the MAPI and CDO interfaces provide a method to access the contact database information and the mail messaging folders and system. The mail messaging folders typically include an InBox and OutBox, as well as user created mail folders.

A user may have more than one profile that will describe their contact information for home, work, or other situations. The profile provides the method of contact to a user receiving the information. For example, a business associate may receive business contact information that has a different phone number and email address than does contact information supplied to friends and family. The profile provides a means to associate and disassociate contact information and gives the owner an added dimension to manage his or her contact information.

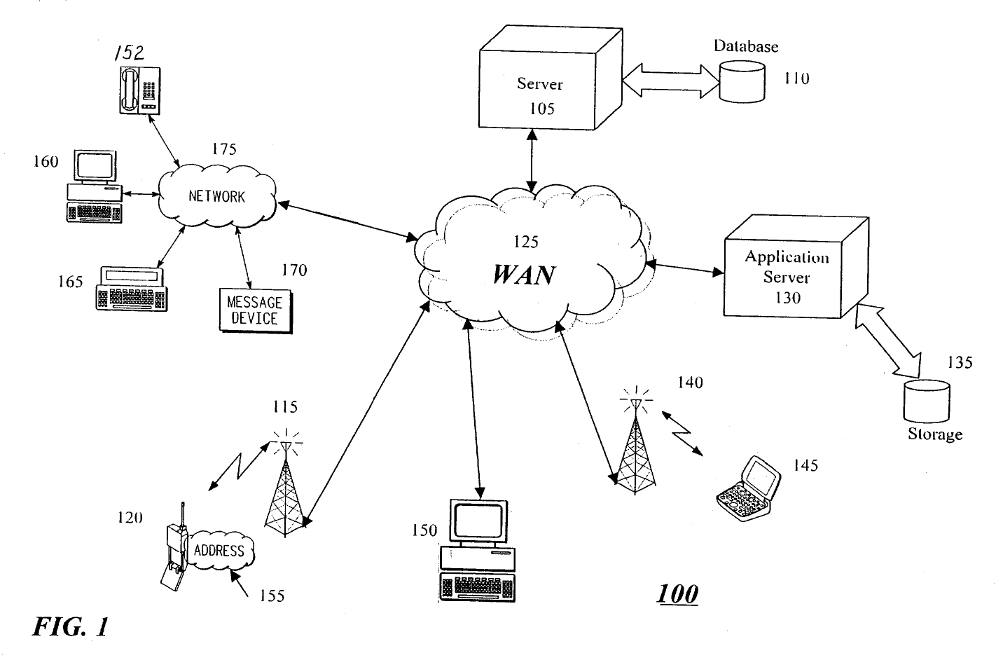

FIG. 1 is a block diagram of a conventional wide area network system 100 configured for operation in accordance with the present invention. The wide area system 100 includes a local area network (LAN) 175, a wide area network (WAN) 125, one or more communication devices 120, 145, 150, 152, 160, 165, 170 (seven shown) coupled directly or indirectly to the WAN 125, one or more servers 105, 130 (two shown) coupled to the WAN 125, and one or more transmitter/receivers 115, 140 (two shown) coupled to the WAN 125. The LAN 175, for example, can employ any one of a number of networking protocols, such as TCP/IP (Transmission Control Protocol/Internet Protocol), AppleTalk™, IPX/SPX (Inter-Packet Exchange, Sequential Packet Exchange), Net BIOS (Network Basic Input Output System) or any other packet structures to enable the communication among the devices and/or between the devices and the shared resources. The WAN 125, for example, can use a physical network media such as X.25, Frame Relay, ISDN, Modem dial-up or other media to connect devices or other local area networks. The WAN 125 utilizes TCP/IP to enable delivery of messages between devices and other networks (not shown) connected to the WAN 125. In the following description, the term “two way messaging system” refers to any of the two way messaging systems mentioned above or an equivalent.

Similarly, it will be appreciated by one of ordinary skill in the art that each of the communication devices 120, 145, 150, 152, 160, 165, 170, in accordance with the present invention, can be a mobile cellular telephone, a mobile radio data terminal, a mobile cellular telephone having an attached data terminal, a personal computer or television having a communication means either built in or attached, or a two way messaging device, such as the “Pagewriter 2000X” manufactured by Motorola, Inc. of Schaumburg, Ill. Similarly, each of the communication devices 120, 145, 150, 152, 160, 165, 170 can operate on a network that uses a physical network such as ARCNET, Ethernet, Token-ring, Local Talk or other network media to connect the computers, which represent wired network nodes into the network. In the following description, the term “communication device” refers to any device capable of transmitting and receiving data over wired or wireless networks.

Each of the communication devices 120, 145, 150, 152, 160, 165, 170 assigned for use in a two-way messaging system have an address or identity assigned thereto which is a unique selective call address in the two-way messaging system. For example, communication device 120 has an address 155 assigned thereto which is a unique selective call address in the two way messaging system for the communication device 120. The addressable device 120 enables the transmission and reception of messages from a transmitter/receiver 115 connected to the WAN 125 from one of the other communication devices 145, 150, 152, 160, 165, 170 or one of the servers 105, 130 also connected to the WAN 125.

As an alternate method to the preferred embodiment, a person may choose to maintain their contact database in a remote database 110 maintained through a server 105. The server 105 may synchronize with the communication device 120 through known methods, such as the syncML industry standard that provides methods of data synchronization between databases and device management. In addition, the server 105 may proxy the contact application client on behalf of the communication device 120 and perform the methods according to the preferred embodiment of the invention. This alternative embodiment eliminates the need for the communication device 120 to be continuously connected to the WAN 125.

In yet another embodiment, an application server 130 connected to the WAN 125 allows the communication device 120 with the unique selective call address 155 to be able to receive and download client applications stored in an application storage 135. It will be appreciated by one of ordinary skill in the art that the device client contact application can be a software program or any other equivalent. In addition, it will be appreciated by one of ordinary skill in the art that the software client program can be loaded through removable disk media, including floppy disk, compact disk, compact flash, secure digital, or other media types.

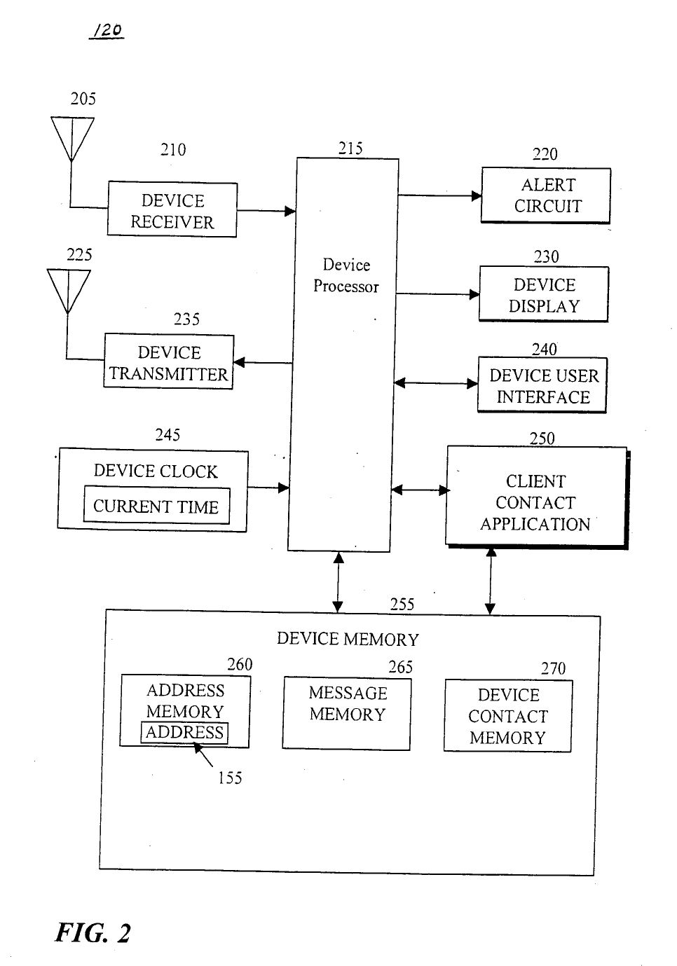

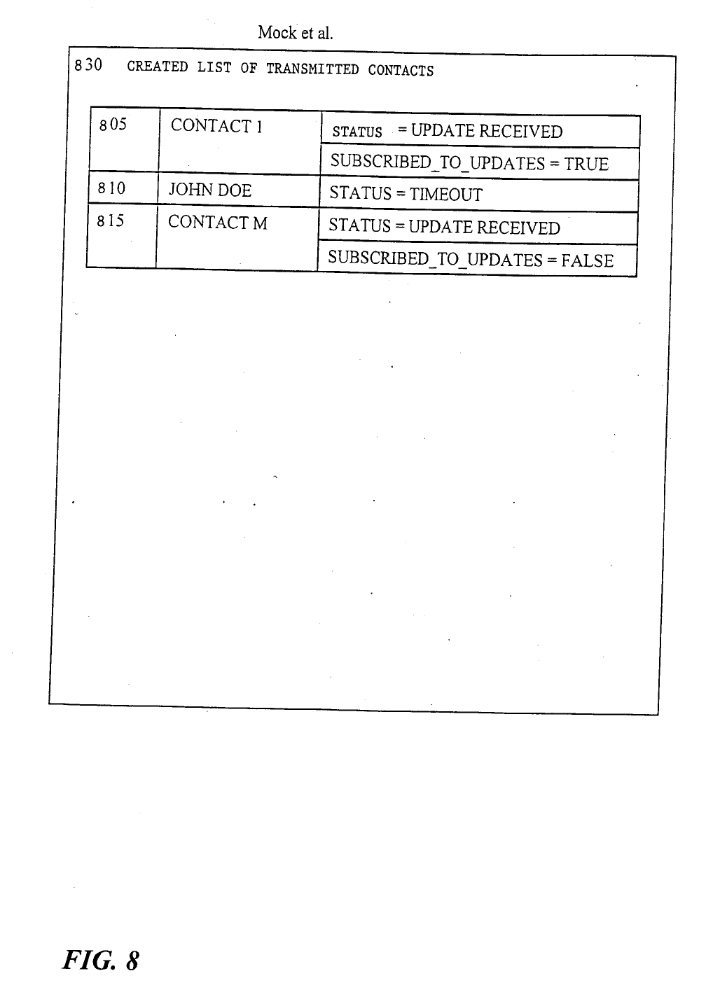

Referring to FIG. 2, a communication device 120 from FIG. 1 includes a first device antenna 205, a second device antenna 225, a device receiver 210, a device transmitter 235, a device clock 245, a device processor 215, a device memory 255, an alert circuit 220, a device display 230, a device user interface 240, and a device client contact application 250. The first device antenna 205 intercepts transmitted signals from the transmitter/receiver 115 (FIG. 1). The first device antenna 205 is coupled to the device receiver 210, which employs conventional demodulation techniques for receiving the communication signals transmitted by the transmitter/receiver 115. Such communication signals include downlink messages as described below with respect to FIG. 8.

Coupled to the device receiver 210 is the device processor 215 utilizing conventional signal-processing techniques for processing received messages. Preferably, the device processor 215 is similar to the MC68328 micro-controller manufactured by Motorola, Inc. of Schaumburg, Ill. It will be appreciated by one of ordinary skill in the art that other similar processors can be utilized for the device processor 215, and that additional processors of the same or alternative type can be utilized as required to handle the processing requirements of the device processor 215.

The device processor 215 decodes an address in the demodulated data of the received message, compares the decoded address with one or more addresses 155 stored in an address memory 260 of the device memory 255 and when an address match is detected, proceeds to process the remaining portion of the received message.

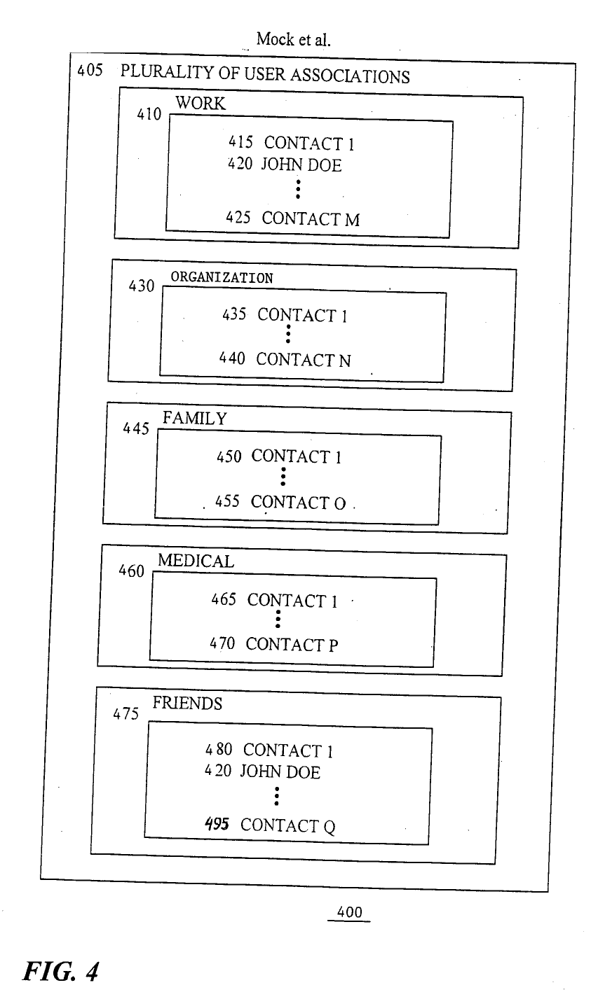

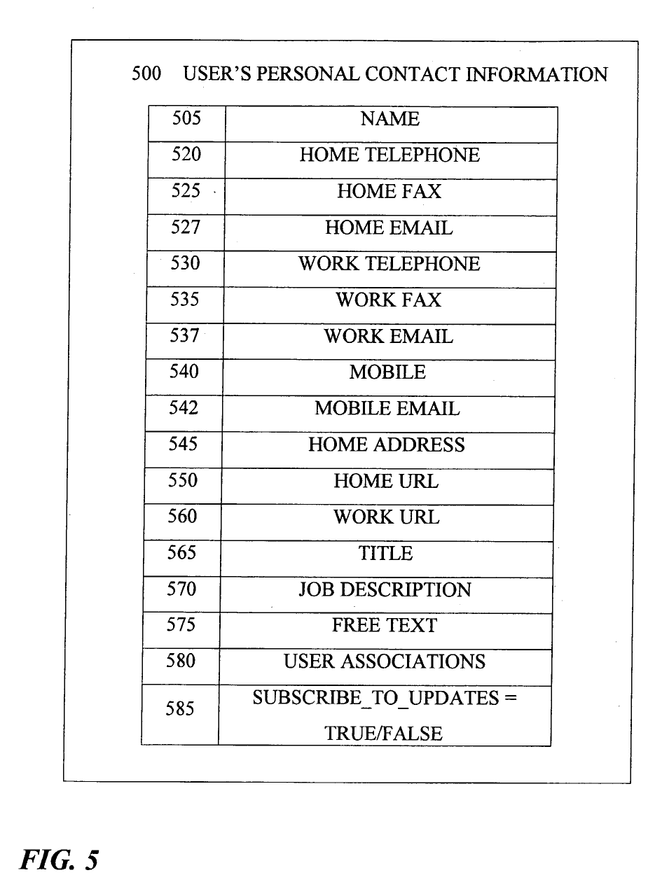

To perform the necessary functions of the communication device 120, the device processor 215 is coupled to the device memory 255, which preferably includes a random access memory (RAM), a read-only memory (ROM), and an electrically erasable programmable read-only memory (EEPROM) (not shown). The device memory 255 is comprised of the address memory 260, a message memory 265, and a device contact memory 270, the latter also being known as a contact database. The device contact memory 270 preferably provides memory storage for a set of user associations, with each user association being made up of one or more contacts as described in more detail below with respect to FIGS. 4 and 5.

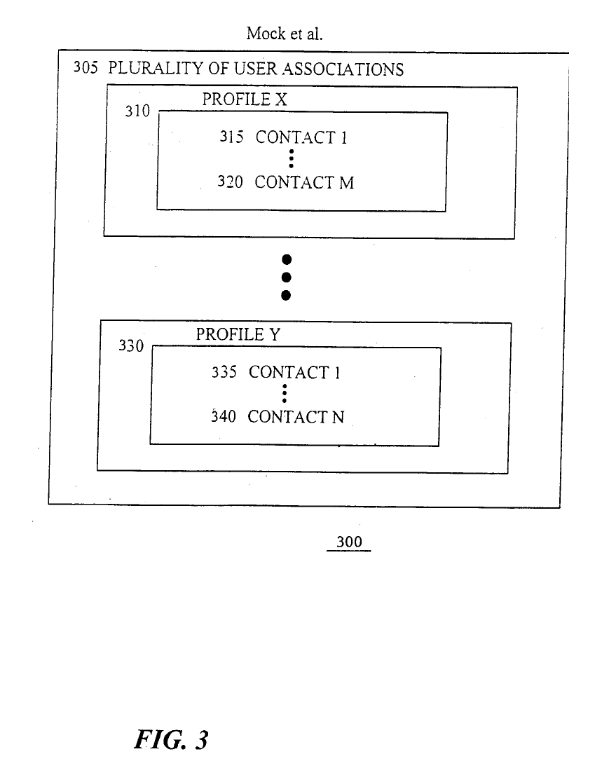

As seen in FIG. 3, a block diagram 300 illustrates a method describing how an owner of contacts can create one or more user associations. The owner presets the user associations 305 by creating a group of profiles (e.g., profile X 310 and profile Y 330). By way of example, these profiles 310, 330 may take on corresponding associations, such as work, family, medical, friends, leisure, hobby or the like. As these profiles 310, 330 take on the associations of these various categories, the respective contacts 315, 320, 335 and 340 are placed within each association. In addition, duplicate contact information can reside in two or more profiles. For example, a contact may be associated with both a work profile and a friend's profile. Commonly available application software such as Microsoft Office Outlook™, as well as other contact management systems allow for the creation of the aforementioned profiles and their respective associations.

FIG. 4 is a block diagram 400 illustrating a method by which an owner of contacts can create one or more user associations. The owner has created a master profile 405 by creating multiple associated sub-profiles, such as work profile 410, organization profile 430, a family profile 445, a medical profile 460 and a friends profile 475. It will be recognized by those skilled in the art that any number of associations or affiliations can be created. Each sub-profile includes its associated contacts. For example, the work profile 410 includes contacts 415, 420, and 425. Likewise, the organization profile 430 includes contacts 435 to 440, the family profile 445 includes contacts 450 to 455, the medical profile 460 includes contacts 465 to 470 and the friends profile 475 includes contacts 420, and 480 to 495. Any contact may appear in more than one associated profile (e.g., contact 420 appears in both the work profile 410 and the friends' profile 475).

FIG. 5 is block diagram illustrating a data structure containing a user's contact information. A user's personal contact information 500 is information given to other individuals or means by which they can contact the owner of the information. At a minimum, the contact record data structure includes fields containing a name 505, one or more of the addresses 545, 555, one or more email addresses 527, 537, 542 and one or more of the owner's phone numbers 520, 530, 540 and fax 525, 535. For business contact information the owner may have only his name 505, work telephone 530, work email 537, work fax 535, mobile 540, mobile email 542, work address 555, work URL address 560, title 565 and/or job description 570 while omitting home information (520, 525, 527, 545 and 550). Space is also provided for free text 575 that is available for additional information that needs to be categorized. The owner of the contact information will by default assign a subscription request value SUBSCRIBE_TO_UPDATES 585 to be either TRUE or FALSE. A value of TRUE for SUBSCRIBE_TO_UPDATES 585 informs the recipient of the personal contact information 500 that the sender or owner of the contact information 500 desires to receive updates to the recipient's contact information. A value of FALSE for SUBSCRIBE_TO_UPDATES 585 informs the recipient of the personal contact information 500 not to inform the sender or owner of the contact information 500 when the recipient's contact information changes. The recipient of the contact information will associate the contact information with one or more associated profiles 410, 430, 445, 460 and/or 475. This is accomplished by assigning the one or more associated profiles in the USER ASSOCIATIONS field 580. For example, if a User JOHN DOE sent his contact information then the recipient would associate his contact information with the work profile 410 and friends profile 475 and the entry for USER ASSOCIATION 580 would contain work 410 and friends 475.

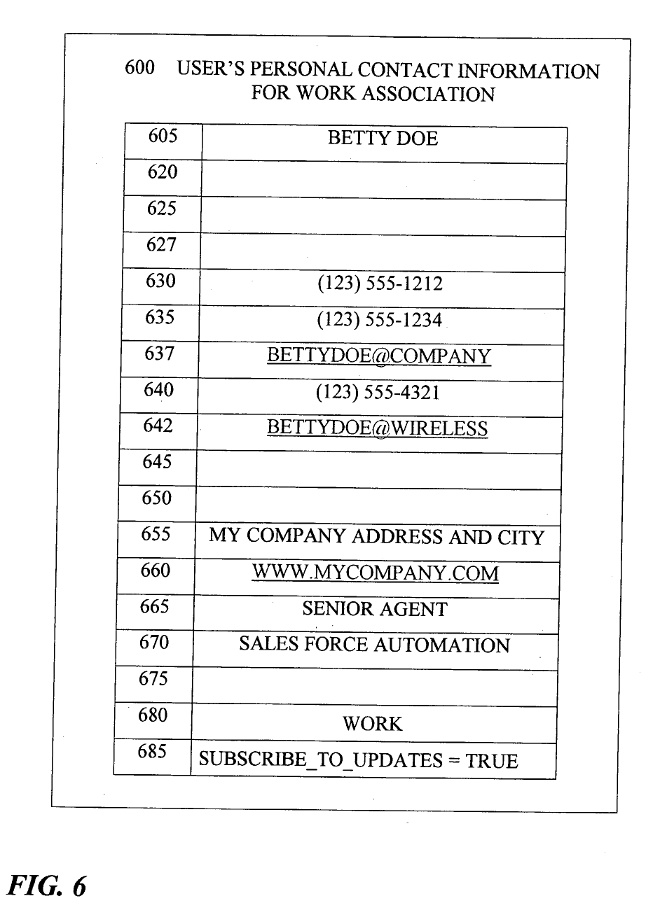

FIG. 6 is a block diagram further illustrating the data structure of FIG. 5. In this illustration, the owner of the contact information 600 has created a listing of information that describes the method of contact while at work. The owner Betty Doe 605 has set the SUBSCRIBER_TO_UPDATES 685 to a TRUE value so that any person receiving the contact information 600 will be able to provide updates where changes have occurred in their own contact information. As shown in FIG. 6, Betty Doe's contact information includes contact numbers for work phone 630, work fax 635, work email 637, mobile phone 640, home email 642, contact addresses for work address 655, work URL 660, title 665, job description 670, user associations 680 and space(s) for free text 675. Optionally, Betty Doe excluded the home telephone 620, home fax 625, home email 627, home address 645, and home URL 675.

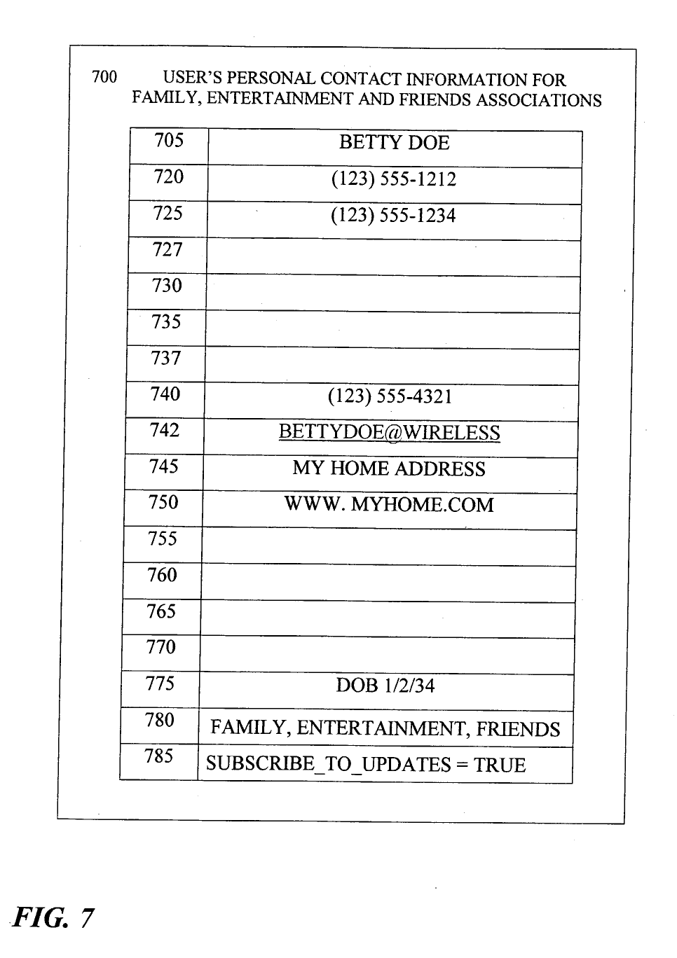

FIG. 7 is a block diagram of a data structure contained within an electronic device that tracks one or more contacts within profiles as seen in FIG. 4, such as profiles 410, 430, 445, 460 or 475 that are currently receiving updated information. In this illustration, the profile 700 shows a user's personal contact information being placed within one or more of the recipients profiles, for example, family, entertainment or friends. Specifically, the contacts name 705, contact numbers 720, 725 and 740, contact addresses 745, 750, birth date 775 and profile association 780 are depicted in the contact information 700. Optionally, the contact information work phone 730, work fax 735, work address 755, work URL 760, title 765 and job description 770 may be left empty. In one application of the present invention, the recipient makes one or more chances in their own contact information which results in other users that have requested a SUBSCRIPTION_TO_UPDATES 785 to a value of TRUE and belong in one or more associations 410, 430, 445, 460 and/or 475 will receive the changes in contact information.

FIG. 8 is a block diagram that further exemplifies the list of recipients that have been transmitted 830 the updated contact information. The transmitted contact list includes the name of the contact as well as the status of the received message i.e. an acknowledgement that the contact was received and whether they were a subscribed contact to receive updated information 805, 810 and 815.

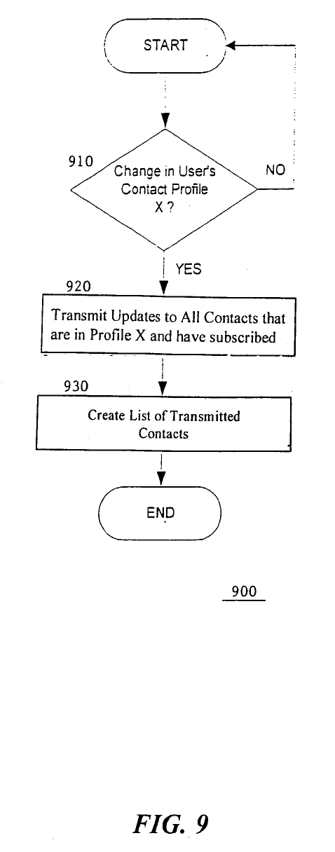

As seen in FIG. 9, a flowchart illustrates a method 900 for broadcasting contact information updates in a peer-to-peer fashion to each member of a profile that has a subscription request, once the user updates the contact information for a particular profile. In the event that the user amends 910 his contact profile, the updated information is broadcast 920 to all contacts that are in a specific profile (e.g., profile X) and have subscribed to receive the updates. As will be recognized by those skilled in the art, broadcast information in the current context involves sending email with an attached Vcard™ along with application directives that are interpreted by the add-on application at the recipient's device. Email communication is but only one of several possible methods to broadcast information. Other transport mechanism might include; infrared access Infrared Data Association (IrDA), Bluetooth. 802.11, instant messaging, Short Message Service (SMS), and other dedicated programs utilizing Transmission Control Protocol/Internet Protocol (TCP/IP) or User Datagram Protocol/Internet Protocol (UDP/IP). The application managing the sender's contact database for the Profile X creates 930 a list of contacts that have been transmitted new contact information 830.

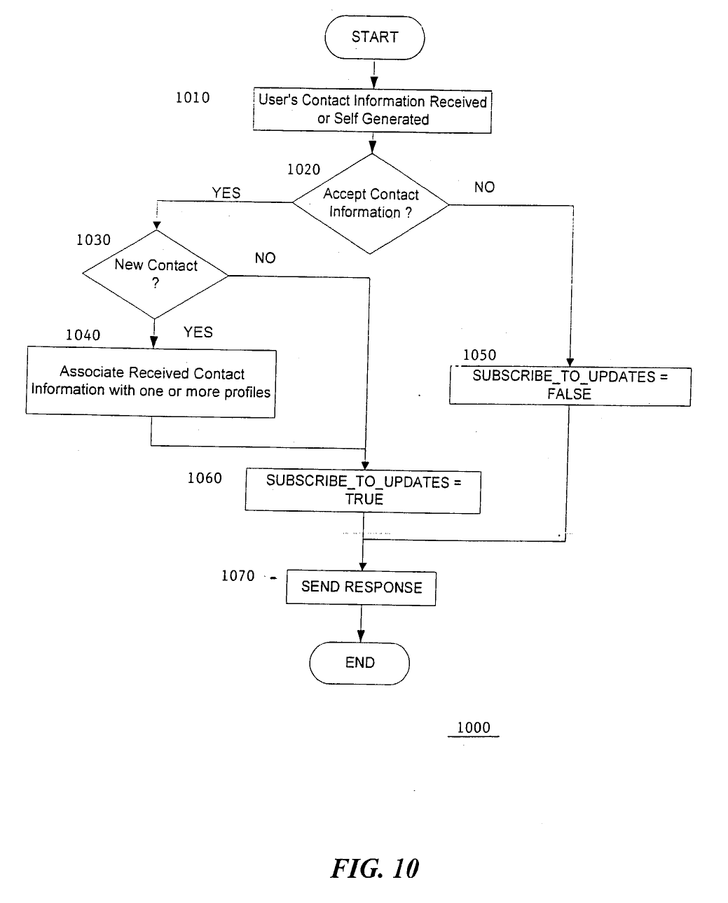

FIG. 10 is a flowchart diagram illustrating a method 1000 of a recipient's electronic device receiving another user's contact information. In step 1010 the owner of the plurality of user associations receives or self-generates contact information 500 (FIG. 5) for a person that the owner of the information desires future interaction. It can be appreciated that the receipt of personal contact information can be done through short range wireless methods including but not limited to: Object Exchange (OBEX) protocol over Bluetooth or infrared access Infrared Data Association (IrDA). In addition, a person can receive updates by using the Vcard™ standard, which is maintained by the Internet Mail Consortium of the Internet Engineering Task Force (IETF) through wide area or local area networks.

The recipient of the contact information then decides whether to accept or reject 1020 the contact information. If the recipient decides to accept the new contact information, it is first determined 1030 whether this is a new contact. If it is a new contact then the received contact information 500 is associated 1040 with one or more profiles 405. The user associations 580 can be one of many values, and for example may include but should not be limited to: WORK 410, ORGANIZATION 430, FAMILY 445, MEDICAL 460 and FRIENDS 475. Thus, the recipient then generates 1060 a TRUE value for the SUBSCRIBER_TO_UPDATES value and subscribes to the updates. This is also the case when the contact information is not new contact information. A subsequent response is then sent 1070 to the client software 250 on the electronic device 120 belonging to the owner.

A user when viewing the contact information may realize that the personal information of the contact 500 has changed enough that the recipient no longer wishes to keep the contact information. In this case the updated contact information may be rejected 1020. Thus, the electronic device, in response to the user, generates 1050 a FALSE value 585 for the SUBSCRIBE_TO_UPDATES value. This response is sent 1070 to the client software 250 (FIG. 2) on the electronic device 120 (FIG. 1) belonging to the owner. In an alternative embodiment, the response may be transmitted to client software that resides on a server 105 that updates the received contact information.

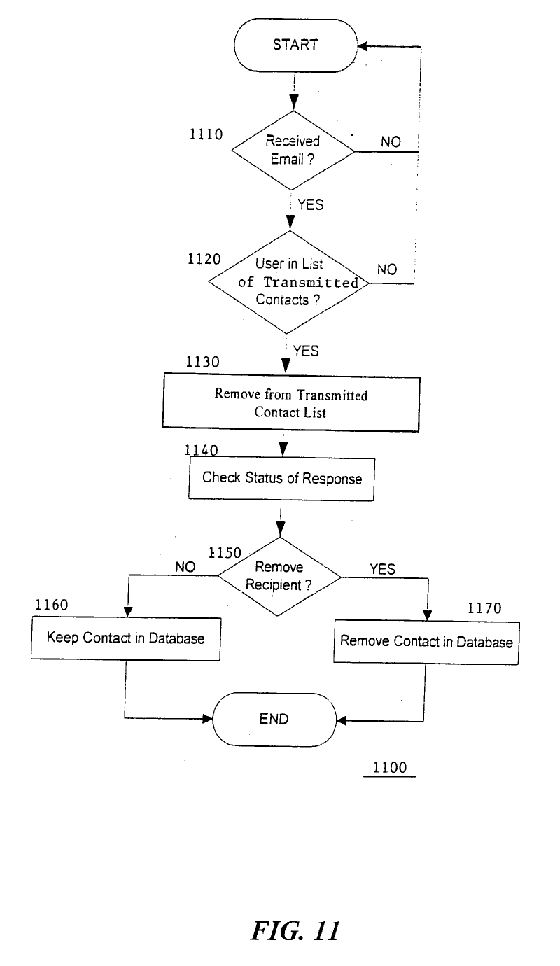

FIG. 11 illustrates a method 1100 for tracking recipient responses 1130 and deciding whether to remove the contact within a profile (410, 430, 445, 460, 475) from the sender's contact database. After the recipient has acted upon the contact information, a status update or acknowledgement message may be sent back to the sender. Such a status update 815 might include such notices that the contact information has been deleted in view of a sender's new role or perhaps the updated information no longer fits users' current job function.

Moreover, the status update 805 may indicate a reply that the contact information has been updated since contact information is still vital to business function of recipient. In accordance with the method, the client contact application 250 in the electronic device 120 checks to determine if an acknowledgement message is received 1110. Once received, a comparison 1120 is made to determine if the acknowledgment is in the list of transmitted contacts 930. A check of the acknowledgment status is next done to determine 1140 if the recipient wishes to remove 1150 their contact information from the sender's database. The recipient of the updated contact information will send a status update 815 when desiring to have themselves removed from the sender's contact database. If the recipient desires to remain in the contact database, a response 830 is received for contact 805, and the information is retained 1160 in the user's database. The client software 250 then acts upon the response and deletes 1170 that recipient from their contact database. It can be appreciated by one skilled in the art that the client contact application 250 will have user preferences that will decide whether to delete, move or take no action on the contact 815.

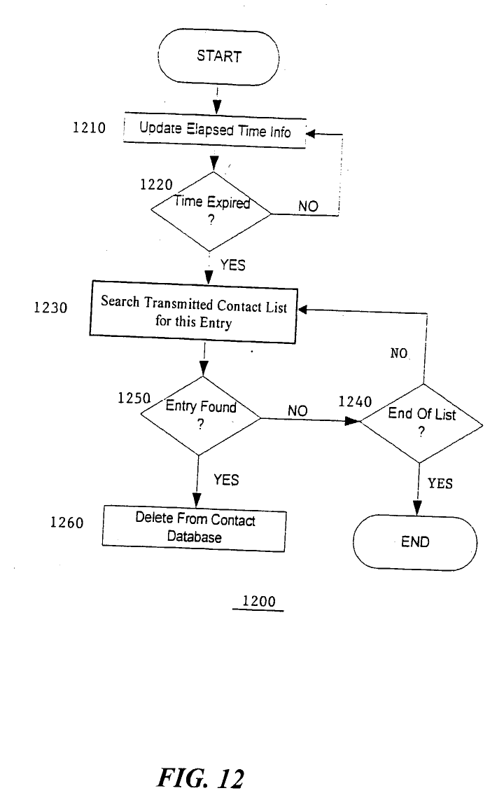

FIG. 12 illustrates a method 1200 where a contact can be deleted from a user database due to the expiration of some predetermined time period. It is inevitable that some users that receive the sender's updated contact information 600 will not act upon this information. The present invention utilizes a method where a lack of recipient response and the amount of elapsed time since sending the message enables the client contact software 250 to make a determination on whether to keep the contact information in the user's database. Elapsed time information is continually updated 1210 utilizing the device clock 245 in order to determine the time since sending the updated information. Once a predetermined time has expired 1220, the list of contacts within a profile that received the transmitted updates is searched to determine if any entries remain 1230. It should be appreciated by one ordinary skill in the art that there are networking protocols which guarantee delivery of messages to a recipient electronic device. Furthermore, there are networking protocols such as Post Office Protocol 3 (POP3) that provide the sender with message received and message read acknowledgement indications and can be used in conjunction with or instead of the electronic device timer. The corresponding contact 420 is deleted 1260 from the contact database once a recipient's identification is located 1250 within the list. If the recipient's identification is not found, the transmitted contact list is searched 1240 until the end of the list is reached.

Thus, the present invention provides a method and apparatus for electronically updating changes in contact information where a user can easily transmit updated contact information to one or more persons on a contact list. The method provides a process by which a recipient of the contact information can request that they be automatically deleted from the contact list if they no longer need the information and do not wish to be contacted in the future. Moreover, those persons who do not reply to the updated information may automatically be removed from the contact list after some predetermined amount of time.

While the preferred embodiments of the invention have been illustrated and described, it will be clear that the invention is not so limited. Numerous modifications, changes, variations, substitutions and equivalents will occur to those skilled in the art without departing from the spirit and scope of the present invention as defined by the appended claims.

What is claimed is:

1. A communication device comprising:
a program memory that stores operating instructions for performing particular functions;
a processor, operably coupled to the program memory, that executes the operating instructions stored in the program memory to perform at least the following functions:
store updated contact information for a user of the communication device responsive to user input;
determine members of a contact list that desire to receive changes to the contact information to produce an update group; and
automatically send the updated contact information to remote communication devices associated with the update group; and
a user interface, operably coupled to the processor, for receiving the user input.

2. A computer-readable storage medium comprising operating instructions that, when executed by a processor, cause the processor to:
store updated contact information for a user of a communication device responsive to user input;
determine members of a contact list that desire to receive changes to the contact information to produce an update group; and
automatically send the updated contact information to remote communication devices associated with the update group.

3. A first computer-readable storage medium having stored thereon a data structure for facilitating an automatic update of contact information of a user of a first communication device in a contact record stored in a second, remote computer-readable storage medium that is accessible by the first communication device via a communication link, the data structure comprising:
a first information field containing a name of the user of the first communication device;
a second information field containing at least one user association, the at least one user association indicating at least one relationship between the user of the communication device and a user of the contact record;
at least a third information field containing contact information for the user of the communication device, said contact information being based on the at least one user association; and
a fourth information field containing an indication as to whether the second computer-readable storage medium desires to receive automatic updates to the contact record.

4. The data structure of claim 3, further comprising at least a fifth information field containing space available for inputting non-contact-related information pertaining to at least one of the user of the communication device and the at least one user association.

5 A method for notifying of changes made to contact information in an electronic contact list comprising:
updating a first electronic contact list with updated information; and
sending the updated information to at least a second electronic contact list in an electronic format based upon changes made to the first contract list.

6. The method of claim 5, wherein the updated information is sent to recipients listed in a database associated with the first electronic contact list.

7. The method of claim 5, further comprising:
sending a status acknowledgement to a sending device that sent the updated information indicating status of an update to the at least a second electronic contact list.

8. The method of claim 7, wherein the status acknowledgement indicates that the update has been made.

9. The method of claim 5, further comprising:
deleting a recipient from the first electronic contact list responsive to a status acknowledgement received from a communication device associated with the recipient.

10. The method of claim 5, further comprising:
deleting a recipient from the first electronic contact list if a status acknowledgement is not received from a communication device associated with the recipient within a predetermined period of time after sending the updated information.

11. The method of claim 5, further comprising:
assigning at least one profile attribute to information in the first electronic contact list; and
transmitting only updated information associated with the at least one profile attribute to the at least a second electronic contact list.

12. The method of claim 11, wherein the at least one profile attribute includes friend, family or business contact.

13. The method of claim 5, wherein contacts in the first electronic contact list may subscribe to updates of information associated with an owner of the first electronic contact list.

14. A method of electronically updating at least one second contact list based on changes made to contact entries in a first contact list comprising:
amending information in an entry in a first electronic contact list;
sending an electronic message to predetermined contacts within the first contact list advising of the amended entry; and
automatically amending the at least one second contact list of recipients of the electronic message with the amended information.

15. A method of electronically updating as in claim 14, further comprising:
sending an acknowledgment message from the recipient of the amended information to the owner of the first contact list indicating that the at least one second contact list has been updated.

16. A method of electronically updating as in claim 15, wherein the status acknowledgement indicates to remove the recipient from the first contact list.

17. A method of electronically updating as in claim 15, wherein a recipient may be deleted from the first contact list if an acknowledgment message if not received within a predetermined time.

18. A method of electronically updating as in claim 14, further comprising:
assigning at least one profile attribute to contacts within the first contact list; and
wherein the predetermined contacts within the first contact list are based upon the profile attribute.

19. A method of electronically updating as in claim 18, wherein a profile attribute includes a designation of friend, family or business contact.

20. A method of electronically updating as in claim 14, further comprising:
allowing recipients on the first contact list to the ability to subscribe to receive amended information.

21. A method for notifying members of a contact list of changes made to contact information of a user of a communication device, the method comprising:
storing updated contact information for the user responsive to user input;
determining members of the contact list that desire to receive changes to the contact information to produce an update group; and
automatically sending the updated contact information to remote communication devices associated with the update group.

22. The method of claim 21, further comprising:
automatically updating contact records at the remote communication devices to include the updated contact information.

23. The method of claim 22, further comprising:
receiving, at the communication device, second updated contact information for at least one member of the contact list; and
notifying the user of the communication device that a contact record of the at least one member of the contact list has been updated to reflect the second updated contact information.

24. The method of claim 21, wherein determining members of the contact list that desire to receive changes to the contact information comprises determining members of the contact list that have subscribed to receive the updated information.

25. The method of claim 23, wherein determining members of the contact list that desire to receive changes to the contact information includes receiving an acknowledgement message from a remote communication device.

26. The method of claim 25, wherein the acknowledgement message includes a request to be removed from the update group.

27. The method of claim 25, wherein the acknowledgment message includes a request to be removed from the contact list.

28. The method of claim 24, wherein a member of the contact list may be removed from the contact list if an acknowledgement message is not received within a predetermined amount of time after the updated contact information was sent.

29. The method of claim 21, further comprising:
assigning at least one profile attribute to an entry within the contact list for designating a type of contact.

30. The method of claim 29, wherein the type of contact includes friend, family or business.

31. The method of claim 29, further comprising:
sending the updated contact information only to remote communication devices associated with members of the update group having profile attributes that correspond to the changes made to the contact information.
